(19) United States
(12) Patent Application Publication
(10) Pub. No.: US 2006/0110954 A1
(43) Pub. Date: May 25, 2006

(54) Connection device

(76) Inventor: Stefan Franzl, Toging-Inn (DE)

Correspondence Address: SCHWABE, WILLIAMSON & WYATT, P.C.;PACWEST CENTER, SUITE 1900, 1211 SW FIFTH AVENUE, PORTLAND, OR, 97204, US

(21) Appl. No.: 11/286,264

(22) Filed: Nov. 23, 2005

(30) Foreign Application Priority Data
Nov. 25, 2004 (EP) 04028032.3

(51) Int. Cl. H01R 12/00

(52) U.S. Cl. 439/76.2

(57) ABSTRACT

Connection device having a coupling device, such as a plug or socket, and a housing that has an outlet opening for a wire assigned to the coupling device. The opening according to at least one embodiment of the present invention is designed such that it can be adjusted with respect to the coupling device according to the conditions related to the installation space of the intended fields of application.

### TECHNICAL FIELD

The present invention relates to connection devices, such as electric plugs. More specifically, the present invention relates to connection devices that have a wired coupling device and a housing with an opening through which the wire associated with the coupling device is fed. For example; in one embodiment, the coupling device is formed by contact elements while the wire assigned to the contact elements is an electric cable.

### BACKGROUND

Connection devices of the aforementioned type frequently are designed to take into account a cramped installation space. Thus, for example, a thickset housing assembly is provided on some printed circuit boards with a slot for a plug. The assembly is designed in such a manner that the wire cannot be fed through the opening in the direction extending parallel to the main surface of the printed circuit board. Instead, the wire must be fed vertically to lie perpendicular to the main surface of the printed circuit board. However, in other applications, the installation space available in the vertical direction extending perpendicular to the main surface of the printed circuit board is so restricted that it is impossible to feed the wire through the opening in a direction extending vertically perpendicular to the main surface of the printed circuit board.

Accordingly, at least two different types of connection devices are typically provided. These include a first type of connection device having an opening that enables a lead-through of the wire in the direction extending substantially parallel to the main surface of the printed circuit board. The second type of connection device includes those connectors having an opening that enables a lead-through of the wire in a direction that extends vertical to the main surface of the printed circuit board. The problems related to space occur not only in connection with printed circuit boards; rather, these issues can also play a role in all those applications where connection devices are used.

### SUMMARY OF INVENTION

In view of these difficulties previously associated with known connection devices for electrically coupling to printed circuit boards and the limitations of available solutions, at least one embodiment of the present invention has been developed to satisfy the need for a connection device to selectively adjust the wire outlet opening with respect to the coupling device particularly according to the conditions related to the installation space of the intended fields of application. More specifically, in one embodiment, a housing of a connection device is configured to receive wire at a variably adjustable outlet opening in one of at least a substantially parallel orientation and a substantially perpendicular orientation relative to a principal axis of a printed circuit board and/or a coupling device, such as a plug or socket, of the connection device.

Accordingly, an objective of the present invention to specify a connection device of the aforementioned type that can be adjusted flexibly according to the conditions related to the installation space of the intended fields of application and thereby overcome the previously mentioned disadvantages of the heretofore known inflexible connection devices of this general type.

With the foregoing and other objects in view, in accordance with the invention, a connection device is provided including a coupling device and a housing that defines an outlet opening for a wire assigned to the coupling device, the outlet opening being configured to adjust selectively with respect to the coupling device.

In accordance with another feature of the invention, the outlet opening can vary around an axis that is engaged with respect to a principal axis.

In accordance with a further feature of the invention, an adjustment axis forms a setting angle (see e.g., α in FIG. 4) of 15° to 75°, preferably 30° to 60°, further engaged 45°, with the principal axis.

In accordance with an additional feature of the invention, a locking device is provided for locking the opening in at least one predetermined position with respect to the coupling device.

In accordance with an added feature of the invention, the housing has a first section assigned to the coupling device and a second section assigned to the opening, where the first section can be adjusted with respect to the second section. In accordance with yet another feature of the invention at least one screwed connection is provided for locking one of the two housing components in at least one predetermined position with respect to the other housing component. In accordance with yet a further feature of the invention, the housing is impervious and in particular watertight.

In accordance with yet an additional feature of the invention, a strain relief coupled with the outlet opening is provided.

In accordance with again another feature of the invention, the coupling device is one of a plug and a socket.

In accordance with again a further feature of the invention, the coupling device has at least one electric contact element.

In accordance with a concomitant feature of the invention, the wire is an electric wire.

With the objects of the invention in view, also provided is a connection device for a printed circuit board described above, the outlet opening according to at least one embodiment of the present invention can be adjusted corresponding to the installation conditions in such a manner that it firstly enables a lead-through of the wire parallel to the main surface of the printed circuit board and secondly also enables a lead-through of the wire through the opening in a direction extending vertical to the main surface of the printed circuit board. Such a flexible type of connection device eliminates the requirement of manufacturing and additionally providing several different types of connection devices.

In accordance with another feature of the invention, the opening can be adjusted randomly with respect to the coupling device. However, the opening according to at least one embodiment of the present invention is designed preferably in such a manner that it can vary around an adjustment axis that is engaged with respect to a principal axis.

Other features that are considered as characteristic for the invention are set forth in the appended claims.

### BRIEF DESCRIPTION OF THE DRAWINGS

Embodiments of the present invention are explained more elaborately and with additional details in the following description, based on exemplary embodiments, but not limitations, and with reference to the enclosed drawing in which like references denote similar elements, of which:

FIG. 1 illustrates a schematic view of a first operating position of the plug according to a preferred embodiment of the present invention;

FIG. 2 illustrates another view of the plug shown in FIG. 1, in a partial cross-section along the line A-A, and

FIGS. 3 and 4 illustrate schematic views of a second operating position of the plug shown in FIG. 1.

### DETAILED DESCRIPTION

In the following detailed description, reference is made to the accompanying drawings which form a part hereof wherein like numerals designate like parts throughout, and in which are shown, by way of illustration, specific embodiments in which the invention may be practiced. It is to be understood that other embodiments may be utilized and structural or logical changes may be made without departing from the scope of the present invention. Therefore, the following detailed description is not to be taken in a limiting sense, and the scope of at least one embodiment of the present invention is defined by the appended claims and their equivalents.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification do not necessarily all refer to the same embodiment, but it may. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional.

According to one embodiment of the present invention, the housing has a first section assigned to the coupling device and a second section assigned to an outlet opening for receiving wire, where the first section can be adjusted with respect to the second section. In other words, in this embodiment of the present invention, the housing is divided into at least two components that can be adjusted with respect to one another. A particularly simple design is thus possible. As indicated above, the connection device according to at least one embodiment of the present invention is preferably either a plug or a socket.

The plug illustrated in the drawings has a housing that has two components 10, 12. The coupling device of housing component 12 can have at least one electric contact element. Four pencil-shaped contact elements arranged in a square protrude from housing component 12. Three of these contact elements are illustrated in the drawings and are marked with the reference numerals 14, 16, and 18. The contact elements 14, 16, 18 serve as a coupling device when the plug is inserted in a corresponding suitable socket or outlet (not illustrated in the drawing).

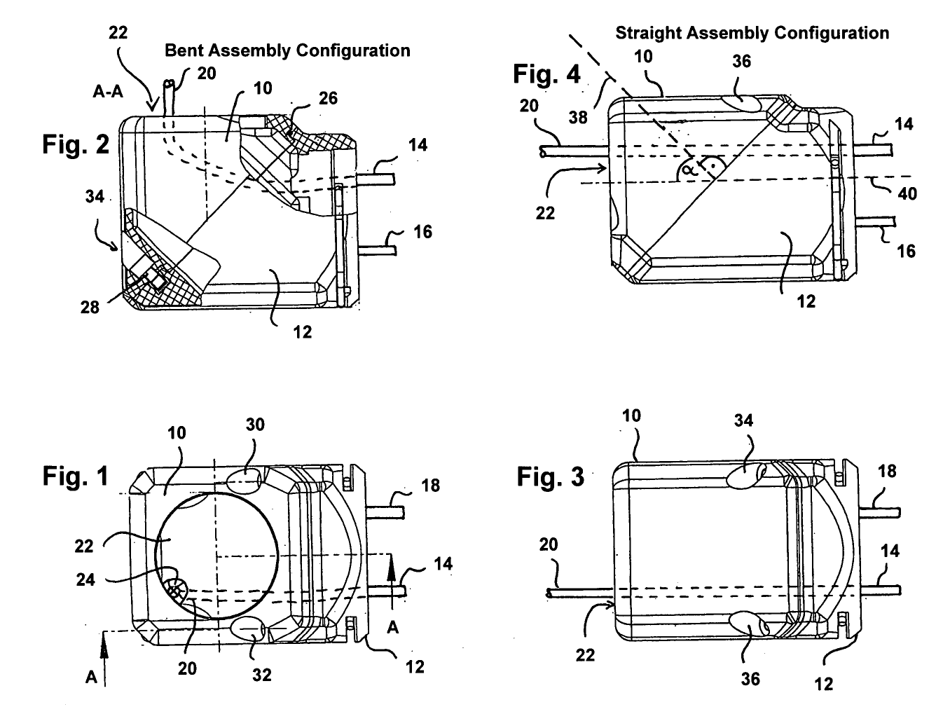

In one embodiment, an electric wire is connected to each of the contact elements. The electric wire connected to contact element 14 is illustrated in the drawings and identified with the reference numeral 20. The wire 20 is illustrated using a dashed line where it extends inside the recess defined by the housing components 10, 12. The wire 20 extends into the recess through an outlet opening 22, defined by the housing component 10 that is adjacent to and in communication with the recess defined by the housing components 10, 12 (see FIG. 1 in particular). Please note that the size, geometry, number and/or placement of the outlet opening 22 may be varied as desired. In similar fashion, the geometry of the recess may be reconfigured as required to suit a particular application.

According to one embodiment of the present invention, a strain relief is provided that is coupled to the opening. In this embodiment, it is sometimes necessary to dimension the part of the wire extending between the strain relief and the coupling device to be sufficiently long so that the wire does not snap out in the event of an adjustment of the opening and thus of the strain relief. The advantage of this embodiment is that the strain relief prevents the wire from snapping out reliably and independent of the position of the opening and that of the strain relief with respect to the coupling device. A strain relief 24 is provided in the region of the outlet opening 22. The strain relief 24 is illustrated schematically in FIG. 1.

According to at least one embodiment of the present invention, the housing is impervious and watertight, in particular. Naturally, this applies particularly to the housing that is divided into two components. In other words, measures are taken in at least one embodiment of the present invention to attach the two housing components tightly to one another. Between the two housing components 10 and 12 lies a seal or gasket that is illustrated in FIG. 2 and is marked with the reference numeral 26. Although the seal 26 is not illustrated in detail in the drawing, measures are taken in at least one embodiment of the present invention to also seal off the outlet opening 22.

In one embodiment, four screws are used to attach the housing component 10 to the housing component 12, of which one screw is illustrated schematically in FIG. 2 and marked with the reference numeral 28. Through-hole passages/openings are provided in the housing component 10 for the purpose of accommodating the attachment screws. These through-hole passages/openings are marked with the reference numerals 30, 32, 34, and 36.

FIGS. 1 and 2 illustrate the connection device in one operating position, in which the outlet opening 22 has a vertical and/or perpendicular alignment with respect to the longitudinal direction of the contact elements 14, 16, 18 of the plug. In contrast, the FIGS. 3 and 4 illustrate the connection device in another operating position of the plug in which the outlet opening 22 is aligned parallel to the longitudinal direction of the contact elements 14, 16 and 18. In order to switch the plug from the one operating position illustrated in FIGS. 1 and 2 to the other operating position illustrated in FIGS. 3 and 4, the housing component 10 with the outlet opening 22 adjusts with respect to the housing component 12 with the contact elements 14, 16, and 18.

According to at least one embodiment of the present invention, in principle, the outlet opening 22 can be adjusted randomly with respect to the coupling device. However, the outlet opening 22 according to at least one embodiment of the present invention is designed preferably in such a manner that it can vary around an adjustment axis 38 that is engaged with respect to a principal axis 40.

In the embodiment illustrated in the drawings, it is possible to adjust the outlet opening 22 by turning and/or rotating the housing component 10 with respect to the housing component 12 around an adjustment axis 38, which in the illustrated embodiment forms a setting angle α of about 45° with the principal axis 40 of the plug, (see FIG. 4). This swiveling/twisting of the housing component 10 around the adjustment axis 38 also results in a rotation/variation of the outlet opening 22 around the adjustment axis 38.

In the above example, the principal axis 40 refers to an axis that lies parallel to the direction in which the connection device is inserted into the complementary connection device. For example, when the connection device is designed as a plug then the complementary connection device might be a socket. In the case of the printed circuit board, for example, this principal axis 40 lies vertical or parallel to the main surface of the printed circuit board.

The setting angle α of the adjustment axis 38 with respect to the principal axis 40 determines the variation of positions of the opening with respect to the coupling device. The adjustment axis 38 preferably forms a setting angle α of about 15° to about 75°, preferably about 30° to about 60°, and most preferably a setting angle of about 45° with the principal axis 40. A setting angle α of about 45° results in particularly symmetrical proportions.

According to one embodiment of the present invention, a locking device is provided for locking the opening in at least one predetermined position with respect to the coupling device. In other words, this embodiment provides means that prevent a random adjustment of the opening with respect to the coupling device. According to at least one embodiment of the present invention, at least one screwed connection can be provided for locking one of the two housing components in at least one predetermined position with respect to the other housing component. An exemplary locking device includes attachment screws, of which one is marked with the reference numeral 28 in FIG. 2. In one embodiment, the attachment screws 28, must be detached to enable the process of twisting/swiveling the housing component 10. The screws are tightened again following the process of rotating the housing component 10. Thus, a locking device is created that offers the advantage of detachability. In other words, in this embodiment, it is possible to adjust the opening with respect to the coupling device subsequent to any changes in the installation conditions.

The process of adjustment of the plug described above can be carried out both before and after the assembly work, i.e. with the already assembled wire 20. For this purpose, as can be seen particularly in FIG. 2, the part of the wire 20 extending between the outlet opening 22 and the contact elements 14, 16 and 18, i.e. the part of the wire 20 extending inside the housing 10, 12, must be sufficiently long so as to prevent the risk of snapping out.

This application claims the benefit under 35 USC § 119 of prior European Patent Application 04028032.3, filed Nov. 25, 2005, the entire disclosure of this prior application is incorporated herein by reference in its entirety.

The characteristics of at least one embodiment of the present invention, which are disclosed in the above description, claims as well as in the drawing can be essential, both individually and also in any combination, for implementing this invention in its different embodiments.

What is claimed is:

1. A connection device, comprising:
a coupling device; and
a housing that defines an opening for a wire assigned to the coupling device, the opening being adjustable with respect to the coupling device.

2. The connection device as recited in claim 1, wherein the opening can vary around an axis that is engaged with respect to a principal axis.

3. The connection device as recited in claim 1, wherein an adjustment axis forms a setting angle (α) of about 15° to about 75°, preferably about 30° to about 60°, further engaged about 45°, with the principal axis.

4. The connection device as recited in claim 1, further comprises a locking device for locking the opening in at least one predetermined position with respect to the coupling device.

5. The connection device as recited in claim 1, wherein the housing has a first section assigned to the coupling device and a second section assigned to the opening, where the first section can be adjusted with respect to the second section.

6. The connection device as recited in claim 5, further comprises at least one screwed connection for locking one of the two housing components in at least one predetermined position with respect to the other housing component.

7. The connection device as recited in claim 5, wherein the housing is impervious and in particular watertight.

8. The connection device as recited in claim 1, further comprises a strain relief coupled with the opening.

9. The connection device as recited in claim 1, wherein the coupling device is one of a plug and a socket.

10. The connection device as recited in claim 1, wherein the coupling device has at least one electric contact element.

11. The connection device as recited in claim 1, wherein the wire is an electric wire.

12. A connection device, comprising
an coupling device having a principal axis and at least one electric contact element;
a housing having an opening selectively positioned in one of at least two operational states about an adjustment axis; and
wire electrically coupled to the at least one electric contact element extending through the opening.

13. The connection device as recited in claim 12, wherein two of the at least two operational states include a substantially parallel operational state and a substantially perpendicular operational state, the substantially parallel operational state aligning the opening substantially parallel to the principal axis and the substantially perpendicular operational state aligning the opening substantially perpendicular to the principal axis.

14. The connection device as recited in claim 13, the housing further comprises a printed circuit board electrically coupled to the at least one electric contact element and aligned substantially parallel to the principal axis of the coupling device.

15. The connection device as recited in claim 14, wherein the substantially parallel operational state enables a lead-through of the wire parallel to the main surface of the printed circuit board and the substantially perpendicular operational state enables a lead-through of the wire through the opening in a direction extending vertical to the main surface of the printed circuit board.

16. The connection device as recited in claim 12, wherein the adjustment axis forms a setting angle (α) of about 15° to about 75°, preferably about 30° to about 60°, further engaged about 45°, with the principal axis.

17. The connection device as recited in claim 12, wherein the opening is adjusted with respect to the coupling device according to the conditions related to intended installation space.

18. The connection device as recited in claim 12, wherein the connection device further comprises a locking device for locking the opening in at least one predetermined position with respect to the coupling device.

19. The connection device as recited in claim 12, wherein the housing further comprises a strain relief coupled with the opening.

20. The connection device as recited in claim 12, wherein the coupling device is an electric plug.
